(19) United States
(12) Patent Application Publication
(10) Pub. No.: US 2026/0158890 A1
(43) Pub. Date: Jun. 11, 2026

(54) TONNEAU AERO COVER WEDGE, SQUARE FLAT AND NATURAL MECHANICAL RETURN

(71) Applicant: FCA US LLC, Auburn Hills, MI (US)

(72) Inventor: Mark J. Skynar, Auburn Hills, MI (US)

(21) Appl. No.: 18/976,878

(22) Filed: Dec. 11, 2024

(51) Int. Cl. B60J 7/16

(52) U.S. Cl. CPC B60J 7/1607

(57) ABSTRACT

A tonneau cover with a wedge, upper and lower positions has a tonneau cover. A first pair of mechanical struts and a front latch coupled with the first pair of struts. A second pair of mechanical struts and a second latch are coupled with the second pair of struts. A controller activates the first and second latches. Upon activation, the tonneau cover moves between a wedge position, an upper horizontal position and a lower horizontal position.

### FIELD

The present disclosure relates to passenger pick-up trucks and, more particularly, to a tonneau cover.

### BACKGROUND

This section provides background information related to the present disclosure which is not necessarily prior art.

Pick up box tonneau covers have been available in the automotive industry. Generally, there are three static configurations. A first type is where the tonneau cover has an aero wedge shape pick-up box cover with a rear hatch opening. A second type is a square box shape for the largest covered pick-up box volume with a rear hatch opening. The third configuration is a lower flat tonneau cover that is flush with the top surface of the pick-up box. The disadvantages of the current solutions are that they can be static in their general shape, the covers can be expensive and heavy. Also, the customer cannot easily manipulate the pick-up box cover for the highest efficiency, largest volume, or lowest possible position. Thus, it is an economical lightweight manipulative 3-positions tonneau cover is not available. Thus, designers strive to improve art.

Various types of covers have existed in the art. However, they are expensive multi-position tonneau covers that propose using electric motors, actuators, electrical hardware controllers and actuation software to move the tonneau cover from one position to the next. These proposals have been very expensive to produce, require extensive wiring, electrical hardware, software, with higher mass than what an average customer can easily install or remove from a rear pick-up box when needed. Also, in order to qualify as a vehicle aero efficiency enabler, the system would need to naturally return to the most efficient aerodynamic position for most of the vehicle driving situations. This involves additional conditional software to predict what the customer use may be.

The present disclosure reduces costs, returns the tonneau cover naturally to its most efficient position when the customer interacts with the rear tailgate. The customer is at the rear of the vehicle when the system releases to its natural wedge position. The customer can interact with the tonneau cover to adjust it to two additional tonneau cover positions. If the natural wedge position is not the desired shape, then the customer can move it to a square box shape for the largest cover pick-up box volume or a lower flat tonneau that is flush with top surface of the pick-up box. The present disclosure provides a tactile manual operation. The present disclosure provides a tonneau cover that reduces cost, mass, and development time while increasing the overall robustness and durability of the 3-position tonneau cover system compared to the previously solutions.

The present disclosure provides a three position tonneau cover. The cover naturally returns to the highest efficiency wedge position when the rear tailgate is either open, or opened and closed. The present disclosures provides a tonneau cover with a baseline natural aero wedge position, an upper horizontal square tube position for maximum cargo space or a lower horizontal tonneau cover positioned over the cargo box.

### SUMMARY

This section provides a general summary of the disclosure, and is not a comprehensive disclosure of its full scope or all of its features.

According to the present disclosure, a tonneau aero cover with a wedge, square and flat position comprises a tonneau cover with a first pair of mechanical struts and a front latch coupled with the first pair of struts. A second pair of mechanical struts is coupled with a second latch. A release for activating the first and second latches upon activation of the tailgate. The tonneau cover moves between a wedge position, an upper horizontal position and a lower horizontal position. The release is a power lock solenoid, cable release, a pin rod and channel release or a combination of these with a tailgate. The cover includes sidewalls for the wedge aero position. The release is activated upon opening of the tailgate. The cover moves to the wedge position upon open and closing of the tailgate.

According to a second aspect of the disclosure, a pick-up truck comprises a box bed with a rear tailgate. A tonneau aero cover with a wedge, square and flat position is positioned on the box bed that comprises a tonneau cover with a first pair of mechanical struts and a front latch coupled with the first pair of struts. A second pair of mechanical struts is coupled with a second latch. A release for activating the first and second latches upon activation of the tailgate. The tonneau cover moves between a wedge position, an upper horizontal position and a lower horizontal position. The release is a power lock solenoid, cable release, a pin rod and channel release or a combination of these with a tailgate. The cover includes sidewalls for the wedge aero position. The release is activated upon opening of the tailgate. The cover moves to the wedge position upon open and closing of the tailgate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a tonneau cover on a pick-up truck.

FIG. 2 is a schematic view of the tonneau cover moving from the wedge position to the upper horizontal position.

FIG. 3 is a schematic view of the cover moving from the wedge position to the lower horizontal position.

Corresponding reference numerals indicate corresponding parts throughout the several views of the drawings.

### DETAILED DESCRIPTION

Example embodiments will now be described more fully with reference to the accompanying drawings.

Turning to the figures, a pick-up truck is illustrated and designated with the reference numeral 10. The pick-up truck 10 includes a cab and a cargo box 14. The cargo box 14 includes a tailgate 16. A tonneau cover 20 is illustrated in a wedge position extending between the tailgate 16 to the cab 12. When the tonneau cover 20 is in an angled or wedge position, it includes sides 22 for prohibiting the elements from entering into the cargo box 14.

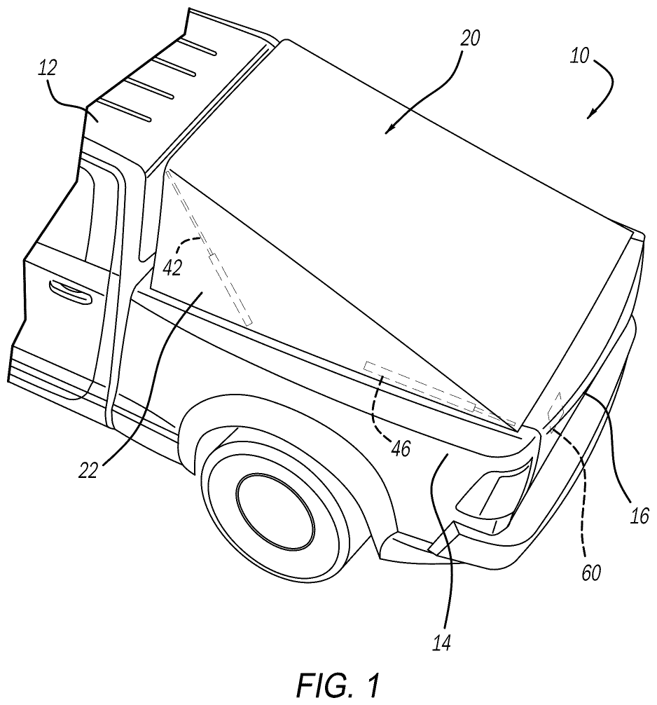

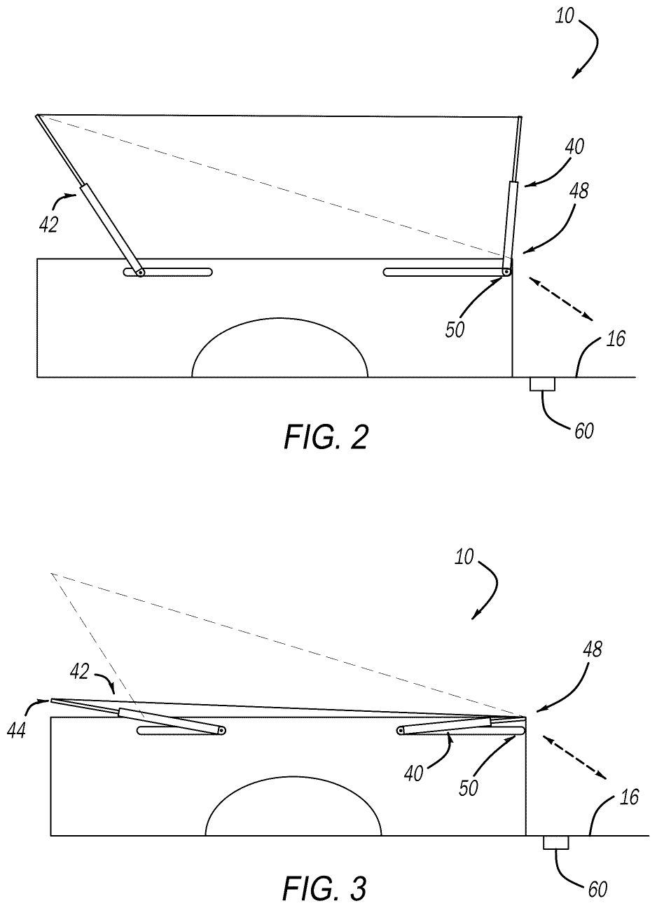

Turning to FIGS. 2 and 3, the tonneau cover is illustrated in its three positions. The wedge position, as illustrated in FIG. 1, an upper horizontal position, illustrated in FIG. 2 and a lower horizontal position illustrated in FIG. 3. In the upper horizontal position, the pick-up truck has its largest covered volume. In the lower horizontal position, the cover is flush with the top surface of the cargo box 14. The tonneau cover 20 naturally returns to its wedge position upon operation of the rear pick-up cargo box tailgate 16. This achieves the lowest vehicle drag from most of the driving conditions.

A mechanism 40 returns the tonneau cover 20 to its natural wedge position. The system 40 includes a first pair 42 of struts at the front 44 of the cargo box 14. The struts 42 are similar to the traditional manual vehicle rear hatchback struts. A set of front latches 44 are coupled with the struts 42. The latches 44 secure the struts in place during operation.

A second pair of struts 46 are positioned at the rear 48 of the cargo box 14. The rear struts 46 are likewise coupled with a set or pair of rear latches 50. The latches 44 and 50 may be released by a controller 60. The controller 60 can include a power lock solenoid, cable release, a pin rod and channel, or a combination of a solenoid cable-rod in combination with the cargo box rear bed tailgate 16.

The operation of the release of the struts 42, 46 achieve the three possible positions of the tonneau cover 20. The purpose of the system 40 is to naturally return the tonneau cover 20 to its natural wedge position upon operation of the rear pick-up cargo box tailgate 16 to achieve the lowest vehicle drag for most of the vehicle driving. In the wedge position, the front struts 42 are in a released position. The rear struts 46 are in a latched position. Thus, the rear struts 46 are in a horizontal position.

When the tonneau cover 20 is moved to its upper horizontal position, the rear latch 50 is released to enable the struts 46 to move to an upper position as illustrated in FIG. 2. The tonneau cover 20 could be manually lifted if the rear tailgate 16 is moved from a closed to an open position. The struts 46 would be released and the rear of tonneau cover 20 slowly moves between positions. Should the operator desire the lower horizontal tonneau cover position, the front of the tonneau cover 20 could be manually compressed.

The front struts 42 are latched at the front of the vehicle or the cargo box 14 in its lower horizontal position. Likewise, the rear struts 46 would be in a latched position. When in the lower horizontal position, if the rear tailgate is opened, the front struts 42 would be released. This enables the tonneau cover 20 slowly raise to its wedge position. Then the tailgate 16 is shut, the tonneau cover locks in its wedge position.

Thus, the present disclosure reduces cost while the tonneau cover 20 returns naturally to the most efficient position when the consumer interacts with the rear tailgate 16. The consumer is at the rear of the vehicle when the system 40 releases the tonneau cover 20 to the natural wedge position. The consumer can interact with the tonneau cover 20 to adjust it into additional, top horizontal and lower horizontal tonneau cover positions. The natural wedge position is not the desired shape for that particular use. Thus, the present disclosure reduces costs, mass and development time while increasing the overall robustness and durability of the three position tonneau cover compared with the known art.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A tonneau cover with a wedge, square and flat position comprising:
a tonneau cover;
a first pair of mechanical struts, a front latch, coupled with the first pair of struts;
a second pair of mechanical struts, a second latch coupled with the second pair of struts;
a controller for activating the first and second latches, upon activation, the tonneau cover moves between a wedge position, an upper horizontal position and a lower horizontal position.

2. The tonneau cover of claim 1, wherein the controller includes a power lock solenoid, cable release, pin rod in channel release or combination thereof in combination with a tailgate.

3. The tonneau cover of claim 1, wherein the tonneau cover includes sidewalls.

4. The tonneau cover of claim 1, wherein the controller is activated upon opening of the tailgate.

5. The tonneau cover of claim 4, wherein the cover moves to the wedge position upon opening of the tailgate.

6. A pick-up truck comprising:
a cargo bed with a rear tailgate;
a tonneau cover;
a first pair of mechanical struts, a front latch, coupled with the first pair of struts;
a second pair of mechanical struts, a second latch coupled with the second pair of struts;
a controller for activating the first and second latches, upon activation, the tonneau cover moves between a wedge position, an upper horizontal position and a lower horizontal position.

7. The pick-up truck of claim 6, wherein the controller includes a power lock solenoid, cable release, pin rod in channel release or combination thereof in combination with a tailgate.

8. The pick-up truck of claim 6, wherein the tonneau cover includes sidewalls.

9. The pick-up truck of claim 6, wherein the controller is activated upon opening of the tailgate.

10. The pick-up truck of claim 9, wherein the cover moves to the wedge position upon opening of the tailgate.
